(19) United States
(12) Patent Application Publication
(10) Pub. No.: US 2017/0091393 A1
(43) Pub. Date: Mar. 30, 2017

(54) Practitioner Network and Patient Coordinated Healthcare System

(71) Applicants: Hasan Ali Muhammad, Huntington Beach, CA (US); David MacLeod, Denver, CO (US)

(72) Inventors: Hasan Ali Muhammad, Huntington Beach, CA (US); David MacLeod, Denver, CO (US)

(21) Appl. No.: 15/275,978

(22) Filed: Sep. 26, 2016

Related U.S. Application Data
(60) Provisional application No. 62/233,054, filed on Sep. 25, 2015.

(51) Int. Cl. G06F 19/00; H04L 29/06; G06F 21/62

(52) U.S. Cl. CPC G06F 19/322; G06F 21/6245; H04L 63/0428; G06F 19/3406; H04L 63/06; G06F 19/3481; H04L 63/0435

(57) ABSTRACT

A practitioner network and patient coordinated healthcare system devised to enable secure and private handling of a patient history as a single Electronic Coordinated Care Portfolio (“ECCP”) accessible through a patient portal via network. Multiple caregivers are able to access partitions in a patient portal comprising a plurality of COMMs for access, upload, and, for some users, download of relevant healthcare information. Access and privileges at each of the plurality of COMMs is controllable by assignment of vertical access tiers to users. Caregivers are thus enabled a holistic understanding of care provision across all caregivers for a particular patient, while patient privacy is protected. The ECCP is encodable as a unique file format to which specific security protocols are enabled and sharing of confidential data is protectable, accessible between authorized users only.

Be it known that we, Muhammad Ali Hasan and David MacLeod, both citizens of the United States, have invented new and useful improvements in a practitioner network and patient coordinated healthcare system as described in this specification, and that this nonprovisional application claims the benefit of provisional application No. 62/233,054 filed on Sep. 25, 2015.

### COPYRIGHT NOTICE

Some portions of the disclosure of this patent document may contain material subject to copyright protection. The copyright owner has no objection to the facsimile reproduction by anyone of the patent document or ensuing disclosure as it appears on record at the Patent and Trademark Office, but otherwise reserves all copyright rights whatsoever.

### BACKGROUND OF THE INVENTION

Various types of methods for linking healthcare information between practitioners and caregivers via Internet protocol are seen in the art. Most are decentralized and particular to various departments or institutions with specific points of presence wherein data is stored. Security concerns abound, as data is encoded and stored as regular file formats executable via everyday applications. Sniffing of files by unauthorized users is common, and sharing of data between departments and institutions messy—even dangerous.

What is needed is a practitioner network and patient coordinated healthcare system that enables secure and private handling of a patient history as a single electronic coordinated care portfolio (“ECCP”) accessible through a patient portal via the Internet between multiple caregivers, departments, and institutions, said patient portal having a plurality of communication portals (“COMMs”) enabled through which particular caregivers, identifiable as authorized users, may upload, download, annotate, and share particular data associated with a patient across platforms and departments depending on access privileges authorized across a plurality of vertical access tiers, wherein patient data is encodable as a particular unique file format to which specific security protocols are enabled by default handling of the unique file format whereby sharing of confidential medical records storable in a central server over multiple points of presence is reserved for authorized and private use only and information pertinent to patient care and caregiver communication is expedited between medical disciplines and departments.

### FIELD OF THE INVENTION

The present invention relates to a practitioner network and patient coordinated healthcare system that enables population of an electronic coordinated care portfolio (“ECCP”) for a patient when a patient portal is opened by an authorized user, whereby data is assembled to populate the ECCP from encrypted data streams securely routed via Internet protocol between points of presence. The patient portal includes a plurality of customizable communication portals (“COMMs”) each configured for use by a particular institution, caregiver, discipline, laboratory, pharmacy, or other authorized user, whereby data pertaining to said particular institution or caregiver is uploadable, annotatable, downloadable, and readable by other users authorized to access said data across a plurality of vertical access tiers granting specific access privileges whereby manipulation of data is controllable between specific and authorized users and interdepartmental communication between caregivers is expedited.

The present practitioner network and patient coordinated healthcare system provides a means of centralizing patient history as an ECCP which may be shared and updated between relevant caregivers authorized to access particular COMMs pertinent to patient healthcare. ECCP files are encoded as a unique file format into a file wrapper, whereby default security protocols are enacted during file handling and execution, and a particular application incorporating default security features is required to execute said file format. Patient history and data is therefore securable and unauthorized access to said data is preventable.

### SUMMARY OF THE INVENTION

The general purpose of the practitioner network and patient coordinated healthcare system, described subsequently in greater detail, is to provide a practitioner network and patient coordinated healthcare system which has many novel features that result in a practitioner network and patient coordinated healthcare system which is not anticipated, rendered obvious, suggested, or even implied by prior art, either alone or in combination thereof.

The present practitioner network and patient coordinated healthcare system has been devised to present a patient portal through which a patient history is sharable between practitioners, caregivers, and a patient by means of an electronic coordinated care portfolio (“ECCP”) deliverable via Internet protocol between a central database and local peripheral devices accessing said central database. The term “central database”, as used herein, is taken to include decentralized storage means wherein encrypted data streams are assembled to populate the ECCP at an end user peripheral device, whereby partitions of data streams and secure socket layers increase security of data handling.

A specific file format is contemplated as part of this invention, said file format designated by a unique extension (such as “.hlsx”, for example, as used herein) which file format enables security protocol handling for particular data system-wide, and also encryption of data and execution of an associated file through additional required protocol, as desired. Such “.hlsx” files, therefore, are used to populate the ECCP whereby a patient history is accessible, readable, sharable, and downloadable between privileged users authorized access across a plurality of vertical access tiers, as will be described subsequently.

The portfolio consists of secure and partitioned communication portals (“COMMs”) networked together between users to generate a patient history readable as an ECCP through a patient portal. The patient portal is a graphic user interface (“GUI”) runnable on a local computing or peripheral device wherein access to COMMs is engendered by interaction with the GUI. User access is controlled through vertical access tiers granting access privileges to particular users, whereby each COMM is partitioned and command and control; read, write; read, annotate; and read-only privileges prevail to dictate access and authorize user interaction with particular data informing each COMM.

Command and control of all data, enabling deletion of data and full authority to access a particular COMM (or multiple COMMs when so designated) is enabled for “Admin” user. Read, write for all data is enabled for “Access-1” users who are authorized to upload and download data, overwrite data, but are unable to delete data from the ECCP. Read, annotate is enabled for “access-2” users, who are enabled to upload notes and annotate COMM files, read COMM files, but have no authorization to download data from COMMs for storage on a local medium, overwrite, or delete data in any COMM. “Read-only” users have access to view and read annotations, notes, and COMM files only, unless any particular COMM file or data is designated “restricted access” by an Access-1 user or Admin user.

Restricted Access requires authorization from an Admin user (and potentially a Access-1 user given authorization privileges, or having been “deputized”, by an Admin user) for any particular user to gain access to said restricted access data.

Thus particular users are enabled higher levels of access privileges to manipulate, delete, overwrite, annotate, upload, authorize users, deputize users, and download data, as well as enable sharing and access between additional users. COMMs may be customized by patient or users having command and control privileges. Default COMMs include a Patient COMM (“Pat-COMM”), a Doctor COMM (“Dr-COMM”), a Diagnostic COMM (“Dn-COMM”), a Pharmacy COMM (“Ph-COMM”), an Imaging COMM (“Im-COMM”), a Dietary COMM (“Di-COMM”), and a Physical Therapy COMM (“PT-COMM”). Additional COMMs may be customized and added by users.

Patient portal provides a default screen panel wherein all relevant patient information is readily displayed as a default screen accessible through the patient portal. Patient information includes name, photo of patient, contact, biometric data (height, weight, blood pressure, etc.), medication information, current prescription information, and other medically pertinent data desirously sharable between caregivers and practitioners. All COMMs are accessible from the default screen. The default screen may tally and update biometric data by consistently measuring biometric data through a peripheral device, such as a wearable peripheral device.

Pat-COMM provides a Pat-COMM panel. Patient can upload notes to Pat-COMM panel for sharing between caregivers and practitioners, as desired. Any user can read patient annotations on the Pat-COMM panel unless restricted access is enacted by patient. Restricted access may restrict users of particular COMMs, or be enacted at a particular access tier, or require authorization of particular individual users.

Dr-COMM provides a Dr-COMM panel wherein primary care physician and/or other caregivers are enabled upload of notes for sharing among users of the patient portal. Notes may be directed to additional COMMs, for example a prescription uploaded to the Dr-COMM may autofill a prescription panel on the Ph-COMM panel for interaction by a pharmacist running the Ph-COMM for the particular patient at a pharmacy.

Dn-COMM provides a Dn-COMM panel wherein diagnostic test results are uploadable by Dn-COMM Admin user or Access-1 user. Test results may be designated restricted access, whereby patient or Dn-COMM Admin user is required to authorize access to any other user. A test results data field is included in the Dn-COMM wherein particular data points are observable. The test results field is particularly useful for patients undergoing repeated diagnostics during treatment, whereby a caregiver at any access tier may garner repeated and updated diagnostic data and thus monitor progress and/or configure medicaments or dosage requirements adapted to results displayed in the data field. Test results data field may be customizable for particular diagnoses and treatments. Hospitalized patients, for example, may have the Dn-COMM panel open proximal their bed whereby caregivers with read-only access can adjudicate progress continuously. Dn-COMM may be integrated with continuous monitoring equipment. Dn-COMM Admin, Access-1, and Access-2 users may add notes and annotations to the Dn-COMM panel. Dn-COMM enables downloading of test results as independent files of selectable file formats for authorized users only. Printing of test results may be enabled for users of lower access privileges when downloading to local storage medium is yet prevented.

Ph-COMM provides a Ph-COMM panel wherein prescriptions and history of prescribed medications is accessible and updateable by Ph-COMM Admin and Access-1 users. Prescriptions may be auto-filled from Dr-COMM Admin and Access-1 user input through the Dr-COMM. Filing of prescriptions may be signaled through the Ph-COMM whereby users read status of prescription for patient. Annotations to the Ph-COMM panel are enabled for Ph-COMM Admin, Access-1, and Access-2 users.

Im-COMM provides an Im-COMM panel wherein imaging results from diagnostic and remote sensing procedures are storable, sharable, downloadable, and annotatable. Imaging results include x-rays, MRIs, scans, and other remote sensed radiological data representable in image files. As with other COMMs, annotation to Im-COMM panel is enabled for authorized users.

Di-COMM provides a Di-COMM panel where dietary and nutritionist caregivers are enabled upload of annotations and notes sharable through the patient portal with other caregivers. As with other COMMs, annotation and access to data is controllable through the vertical access tiers providing particular access privileges (including access to restricted access data) to particular users.

PT-COMM provides a PT-COMM panel wherein physical therapists and caregivers are enabled upload of annotations and notes sharable through the patient portal with other caregivers. As with other COMMs, annotation and access to data is controllable through the vertical access tiers providing particular access privileges (including access to restricted access data) to particular users.

A communication COMM (“Com-COMM”) is included, said Com-COMM enabling sharing of the entire ECCP via secure SMTP or other secure digital transmission (e.g. via SSL, SSH, TLS, etc.). The Com-COMM may encrypt the ECCP for secure transmission between parties. Only patient and Admin users, and other authorized users, may share a patient's ECCP with additional users. In some cases, the patient may have to authorize sharing of the ECCP. Com-COMM may include generation of a file format suitable for sharing with other parties, such as portable document format (“.pdf”) or may make use of the unique “.hlsx” file format to maintain security handling protocols effective when executing or transmitting “.hlsx” files. View of the ECCP may therefore be required by operating particular applications having security protocols embedded therein, which are thence able to execute “.hlsx” files, whereby said ECCP is encrypted and securable for authorized viewing only.

Creation of a COMM in an ECCP effects generation of a cryptographic key matchable to a private key peculiar to each user authorized access to the ECCP. Authorized access may therefore be controlled at specific peripherals wherein the cryptographic key is storable for matching or in portable storage media connectable to peripherals to enable presentation of the private key.

Viewing of an ECCP effects assemblage of disjointed data streams that may be remotely stored separately. Data streams may assemble each COMM, whereby each data stream is encrypted and transmitted separately from separate sources whereby interception of each stream and re-assemblage of each stream, by matched cryptographic keys, is required to view the ECCP. A specific software application may be required to effect reassembly of an ECCP for viewing, whereby the “.hlsx” file format is executable, said specific software application disposed to match cryptographic keys and identify data packets for reassembly through network. Thus default security transmission protocol is enabled and data streams are identifiable and extractable for reassembly into a patient ECCP at peripherals running the application and in possession of appropriate encryption keys.

Thus has been broadly outlined the more important features of the present practitioner network and patient coordinated healthcare system so that the detailed description thereof that follows may be better understood and in order that the present contribution to the art may be better appreciated.

For better understanding of the practitioner network and patient coordinated healthcare system, its operating advantages and specific objects attained by its uses, refer to the accompanying drawings and description.

### BRIEF DESCRIPTION OF THE DRAWINGS

### Figures

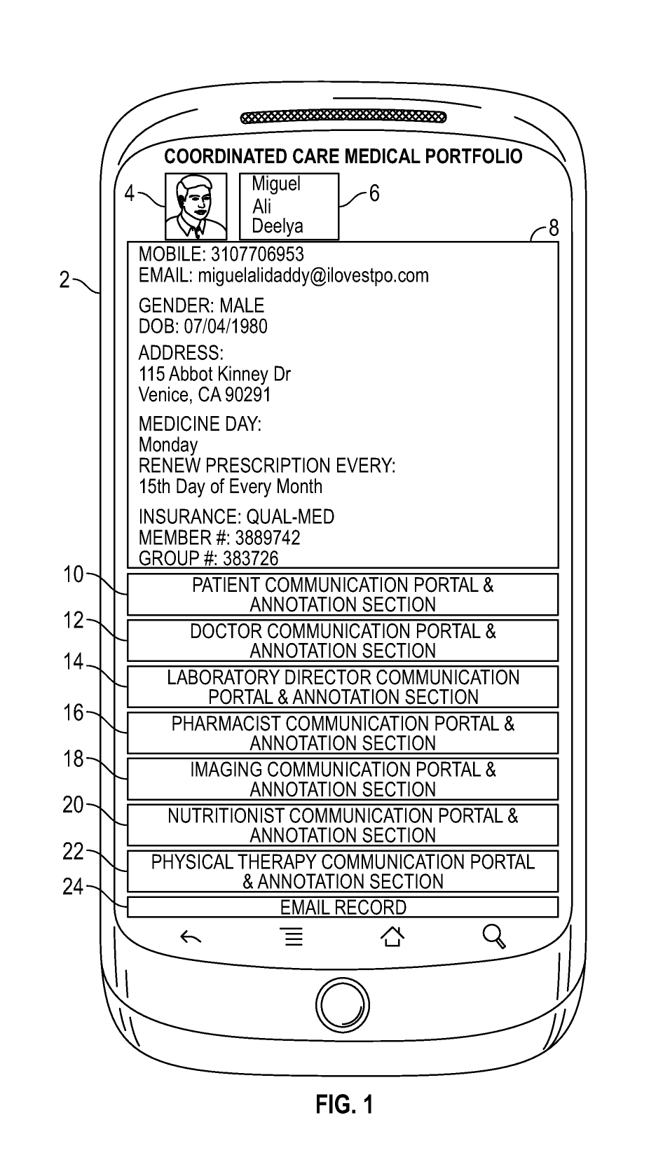

FIG. 1 is a screenshot of a simplified example embodiment of a default screen of a patient portal accessing an electronic coordinated care portfolio (“ECCP”).

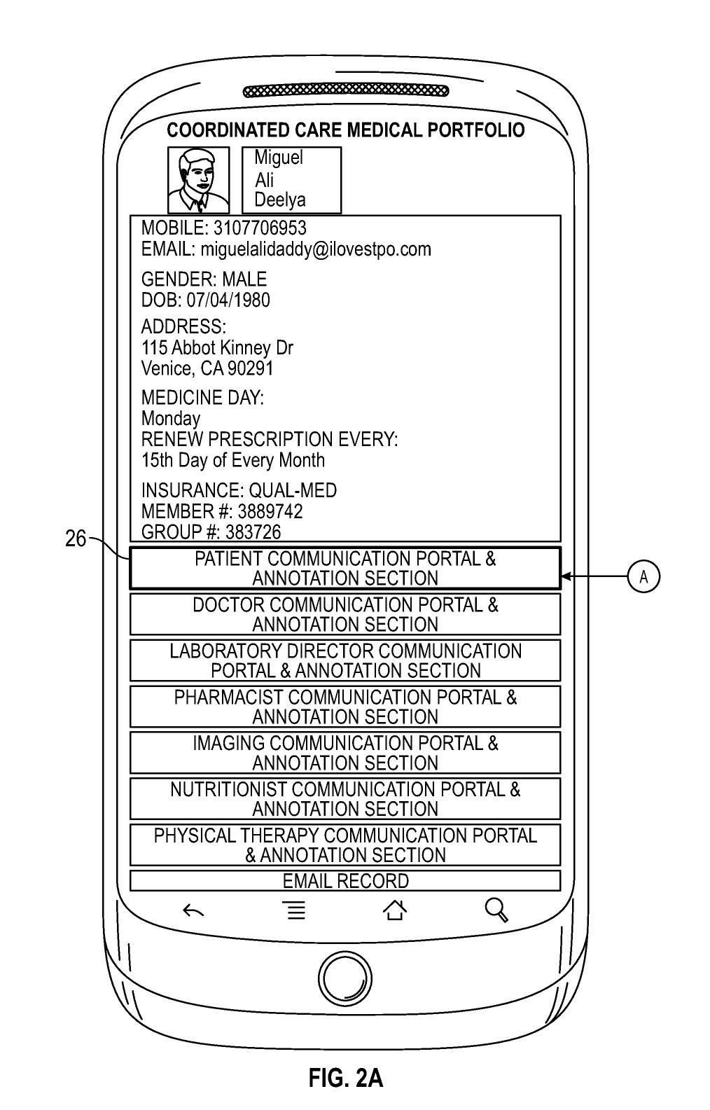

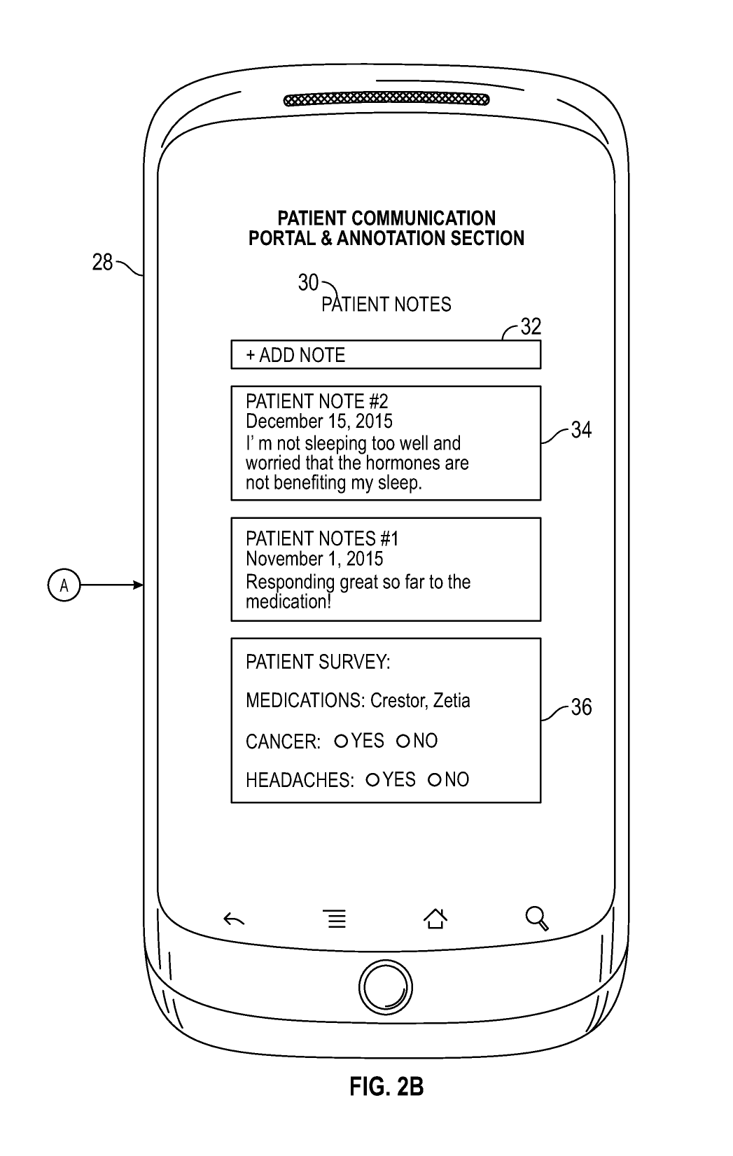

FIG. 2A is a screenshot of a simplified example embodiment of a Pat-COMM panel.

FIG. 2B is a screenshot of a simplified example embodiment of a Pat-COMM panel.

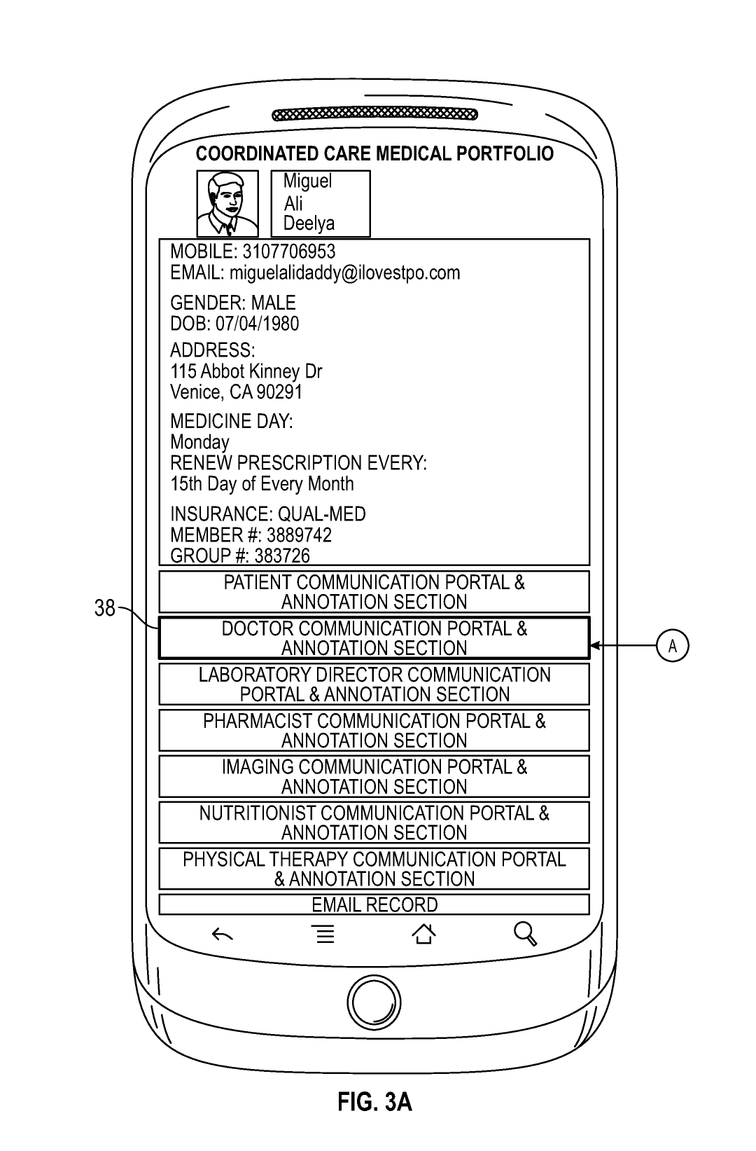

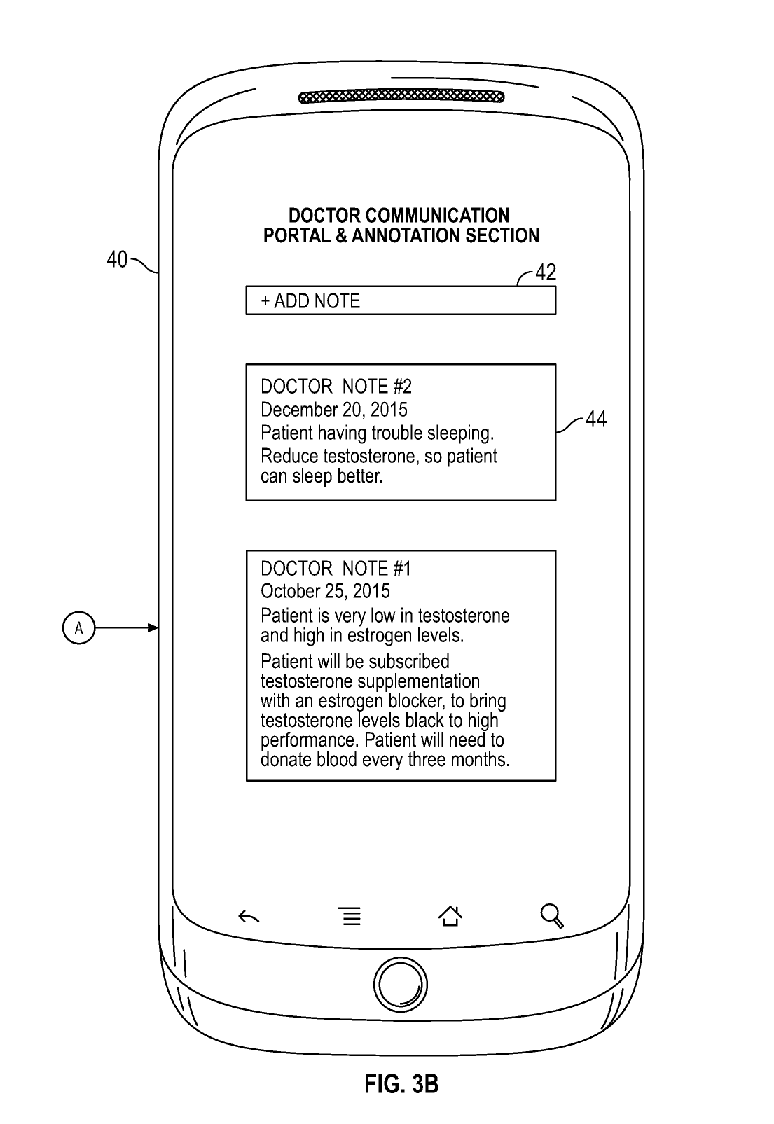

FIG. 3A is a screenshot of a simplified example embodiment of a Dr-COMM panel.

FIG. 3B is a screenshot of a simplified example embodiment of a Dr-COMM panel.

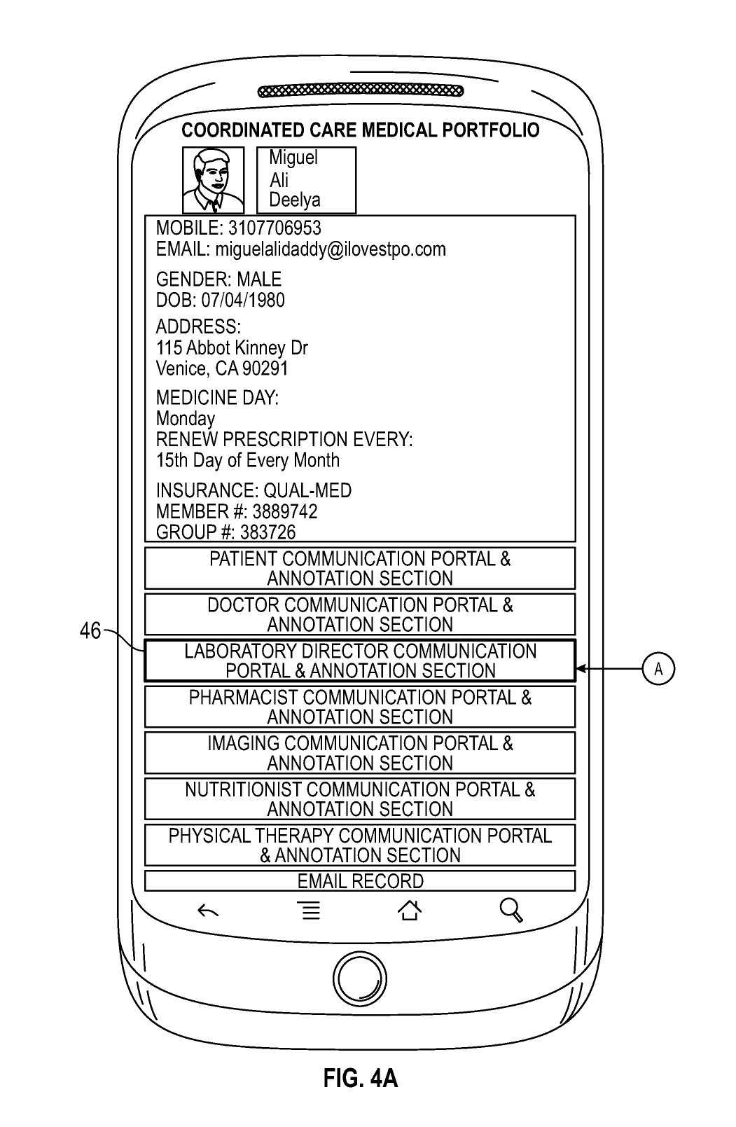

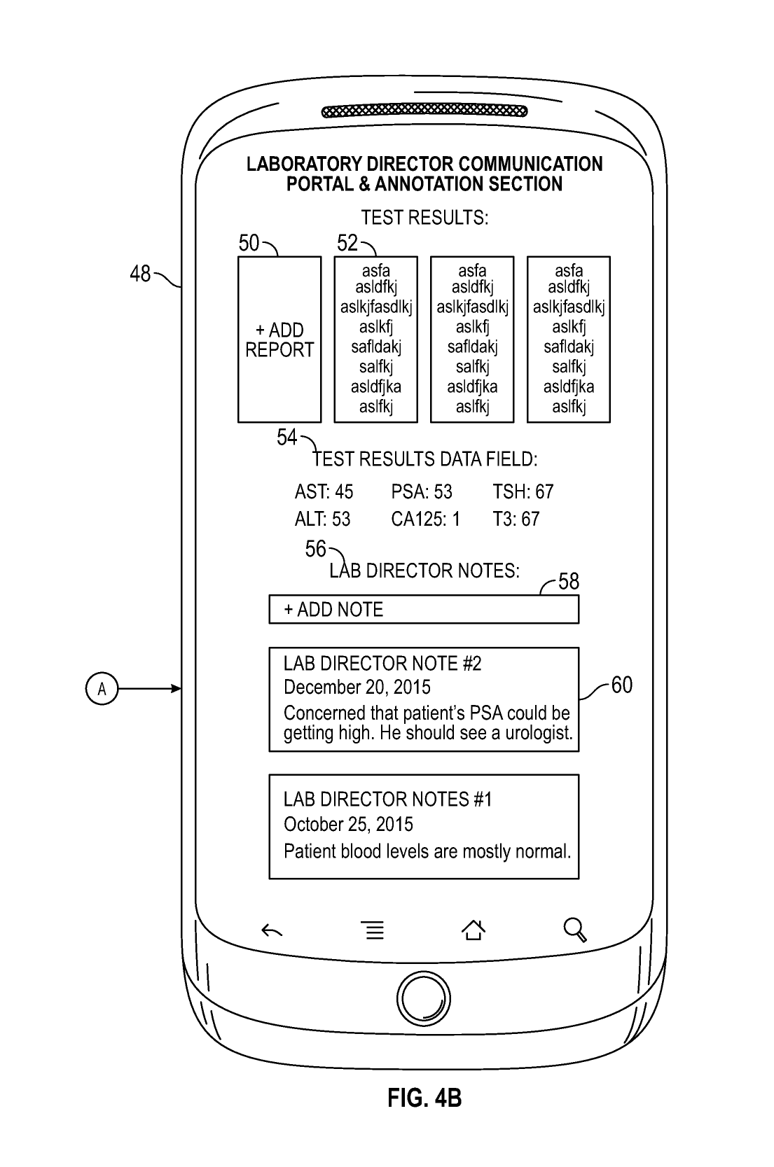

FIG. 4A is a screenshot of a simplified example embodiment of a Dn-COMM panel.

FIG. 4B is a screenshot of a simplified example embodiment of a Dn-COMM panel.

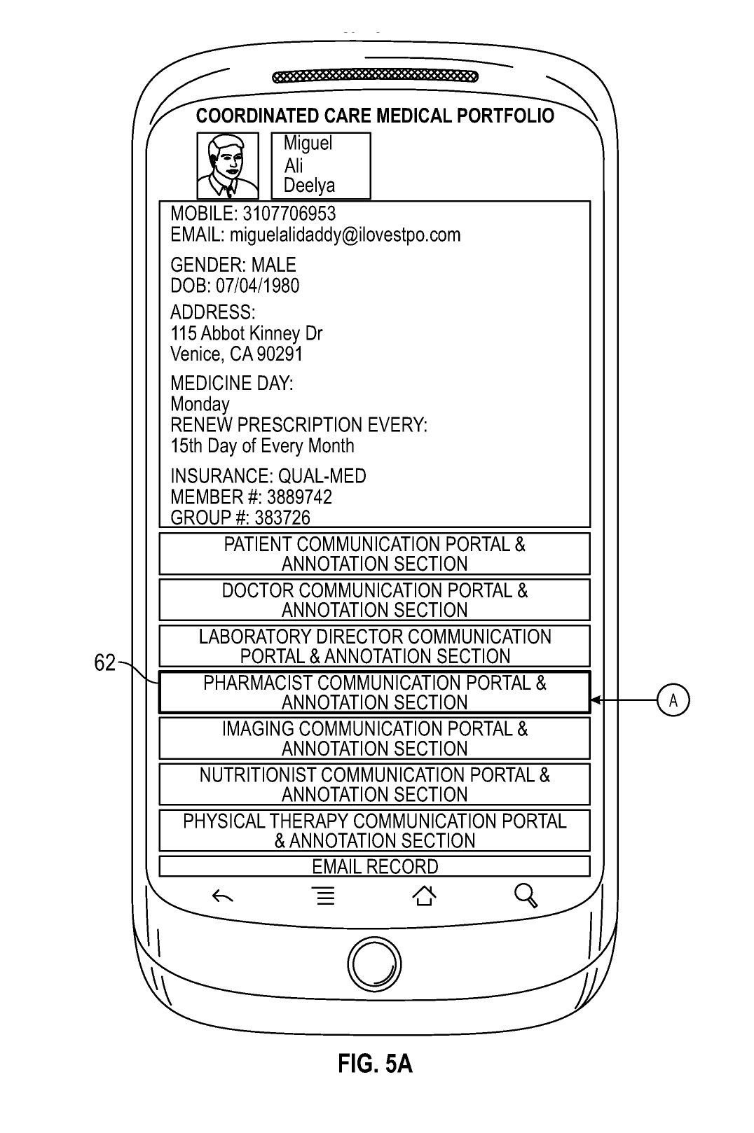

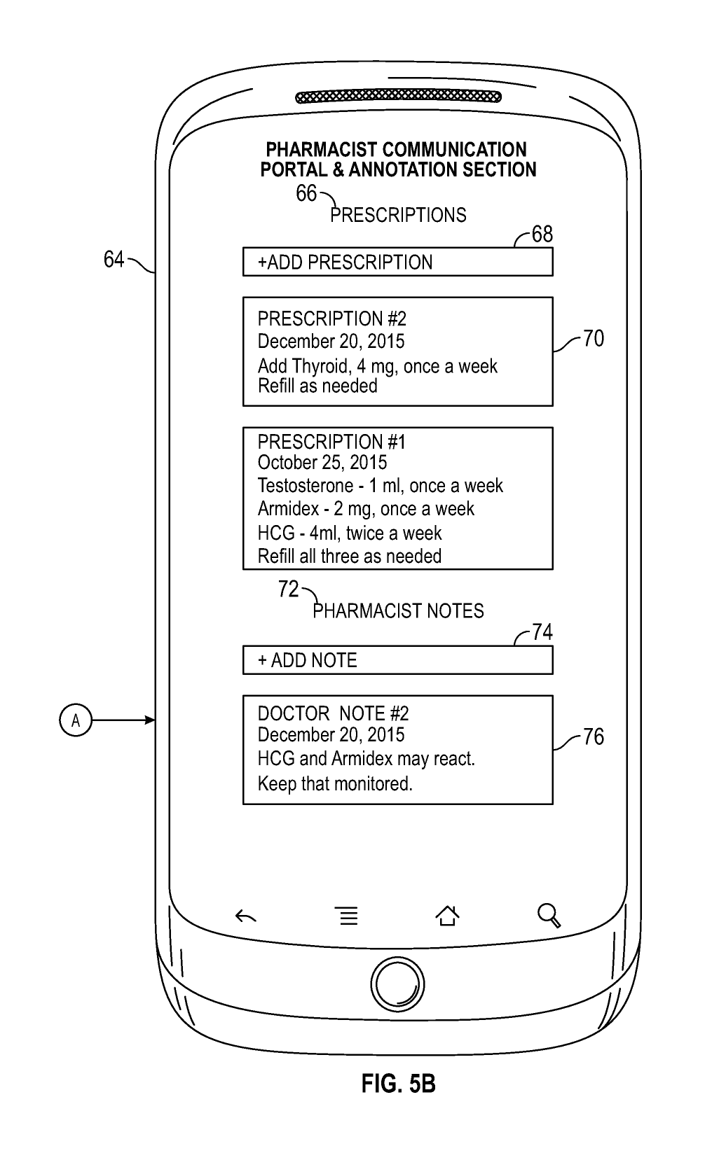

FIG. 5A is a screenshot of a simplified example embodiment of a Ph-COMM panel.

FIG. 5B is a screenshot of a simplified example embodiment of a Ph-COMM panel.

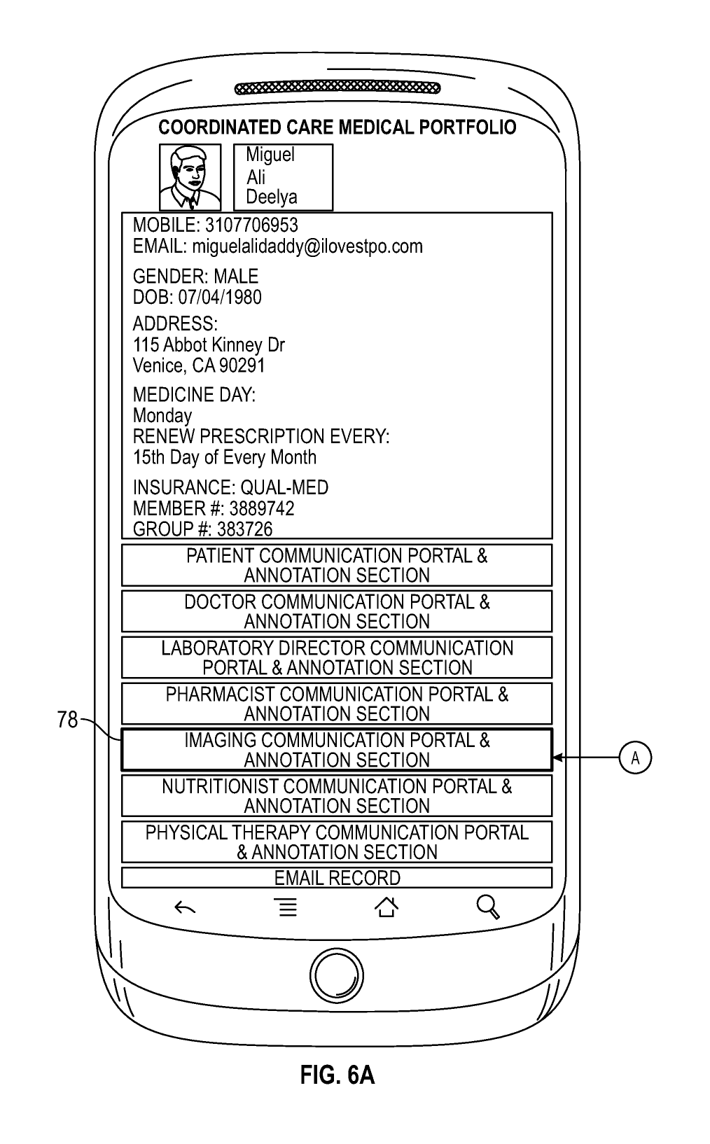

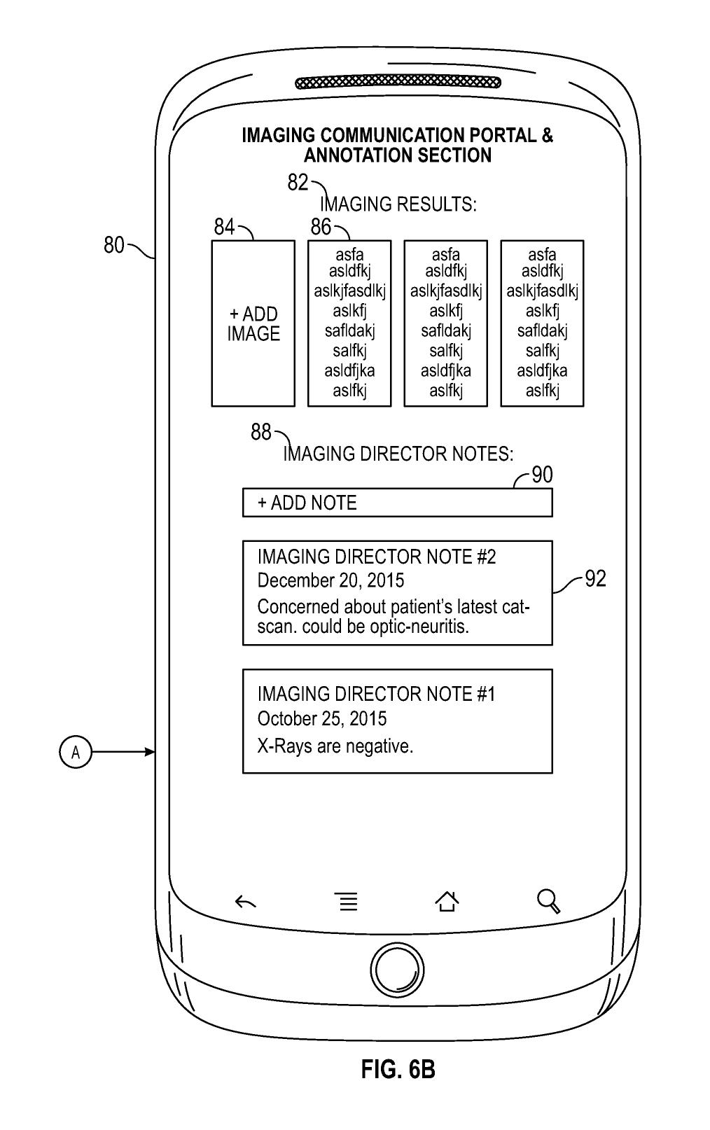

FIG. 6A is a screenshot of a simplified example embodiment of an Im-COMM panel.

FIG. 6B is a screenshot of a simplified example embodiment of an Im-COMM panel.

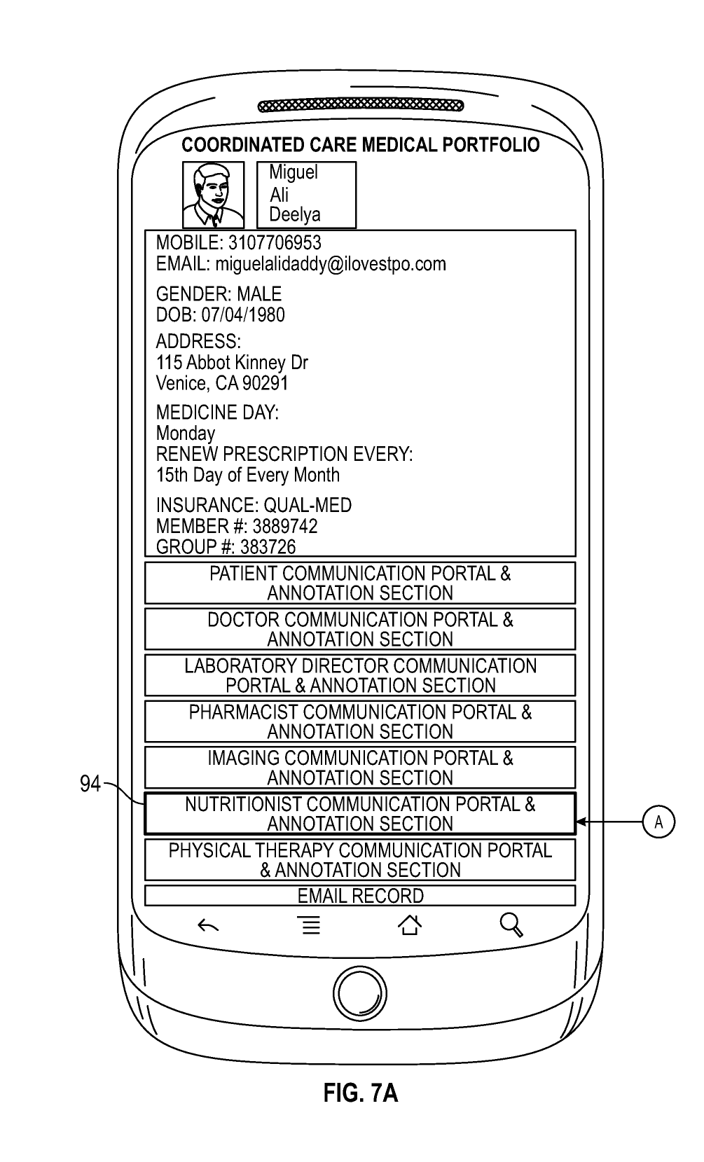

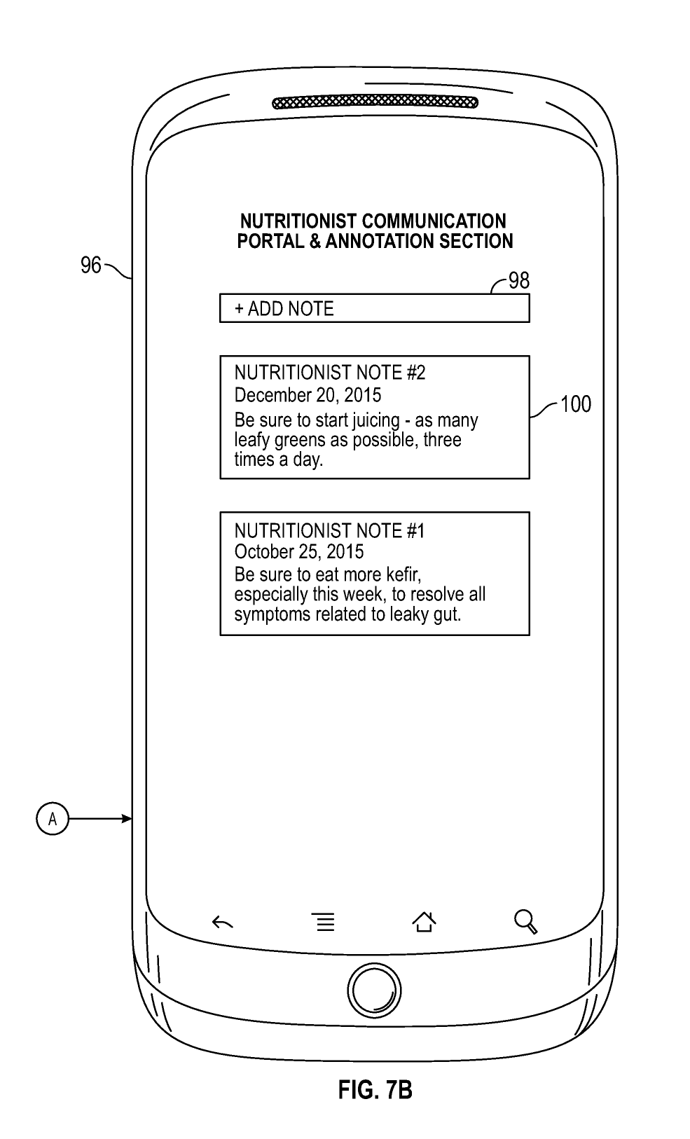

FIG. 7A is a screenshot of a simplified example embodiment of a Di-COMM panel.

FIG. 7B is a screenshot of a simplified example embodiment of a Di-COMM panel.

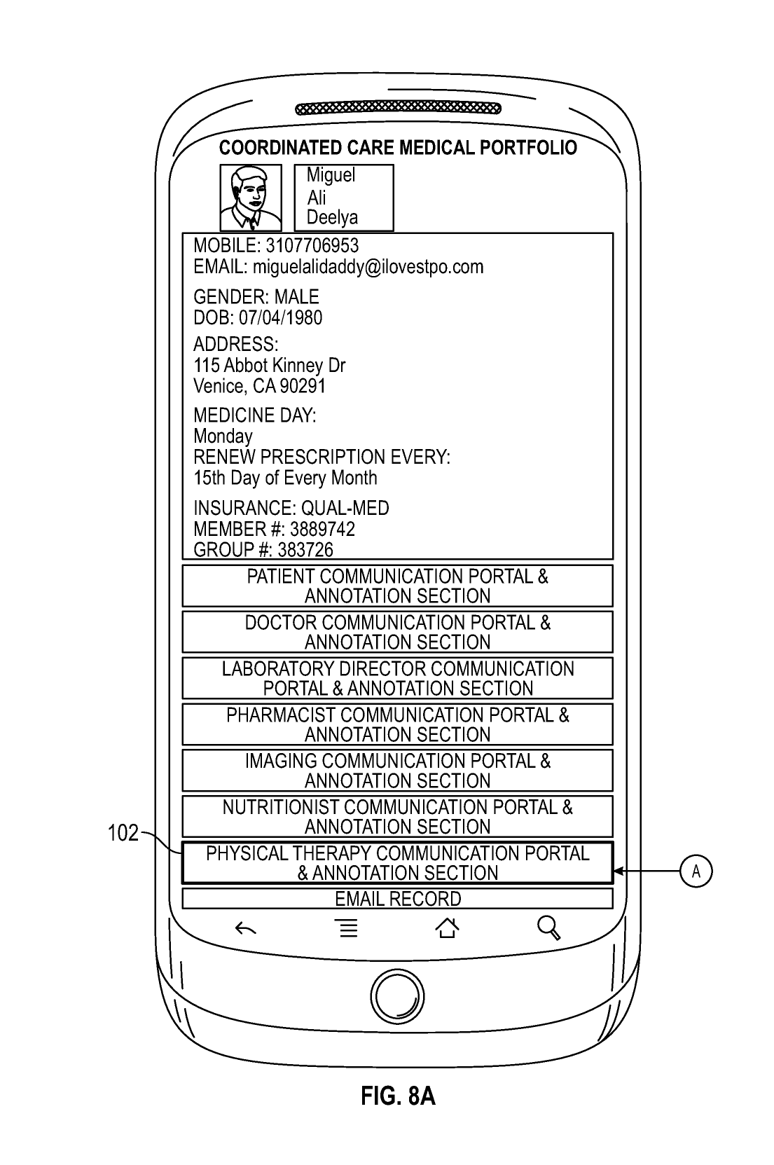

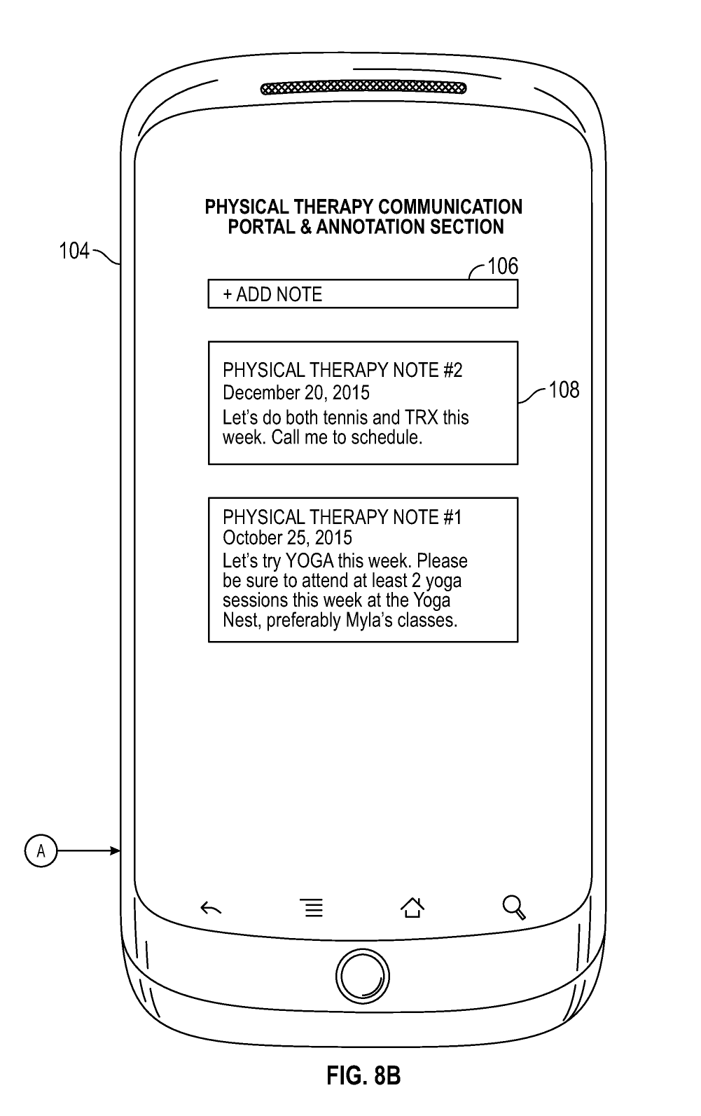

FIG. 8A is a screenshot of a simplified example embodiment of a PT-COMM panel.

FIG. 8B is a screenshot of a simplified example embodiment of a PT-COMM panel.

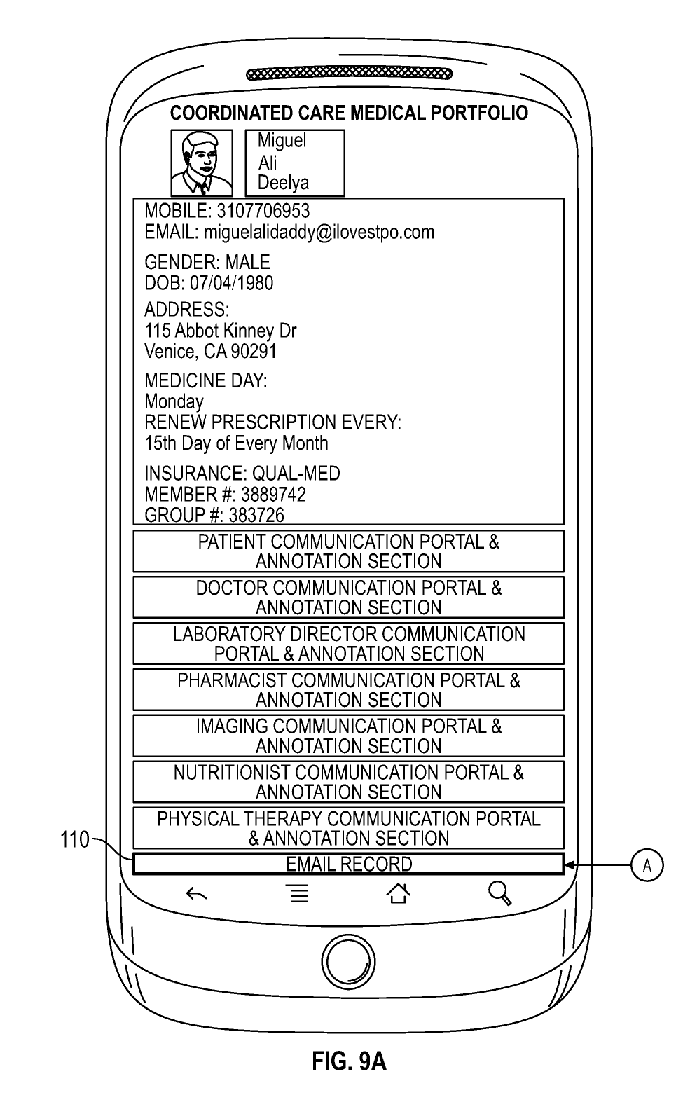

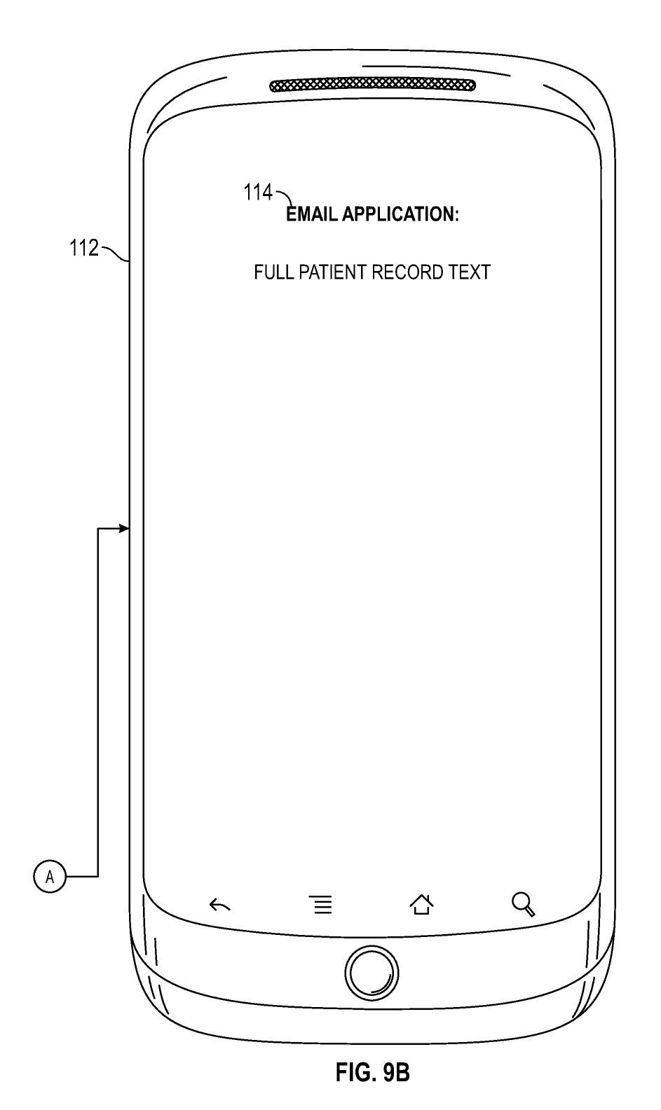

FIG. 9A is a screenshot of a simplified example embodiment of a Com-COMM panel wherein an ECCP is sharable via email protocol, SMTP, STARTTLS SMTP; TLS, SSL, SSH enabled, or other secure email protocol.

FIG. 9B is a screenshot of a simplified example embodiment of a Com-COMM panel wherein an ECCP is sharable via email protocol, SMTP, STARTTLS SMTP; TLS, SSL, SSH enabled, or other secure email protocol.

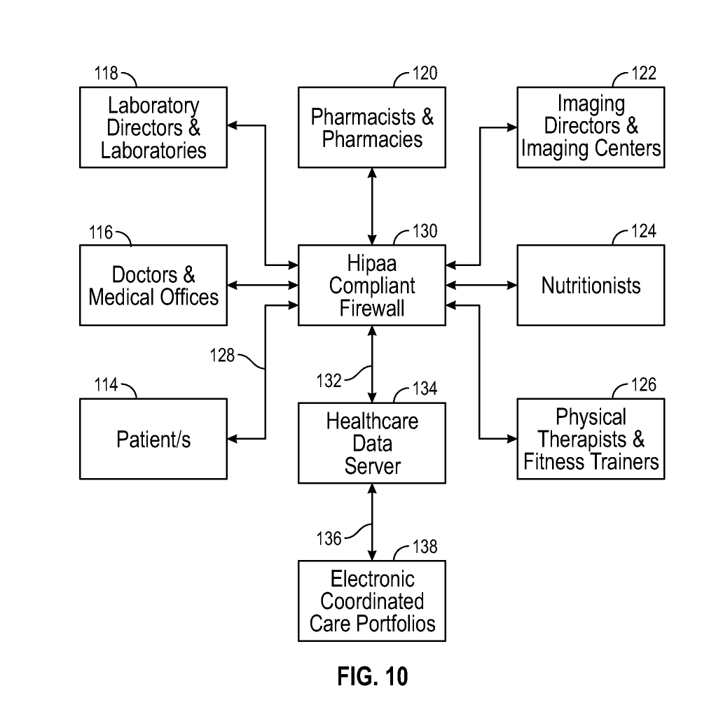

FIG. 10 is a block diagram view of a shared network participating in sharing and updating a patient's ECCP via a patient portal.

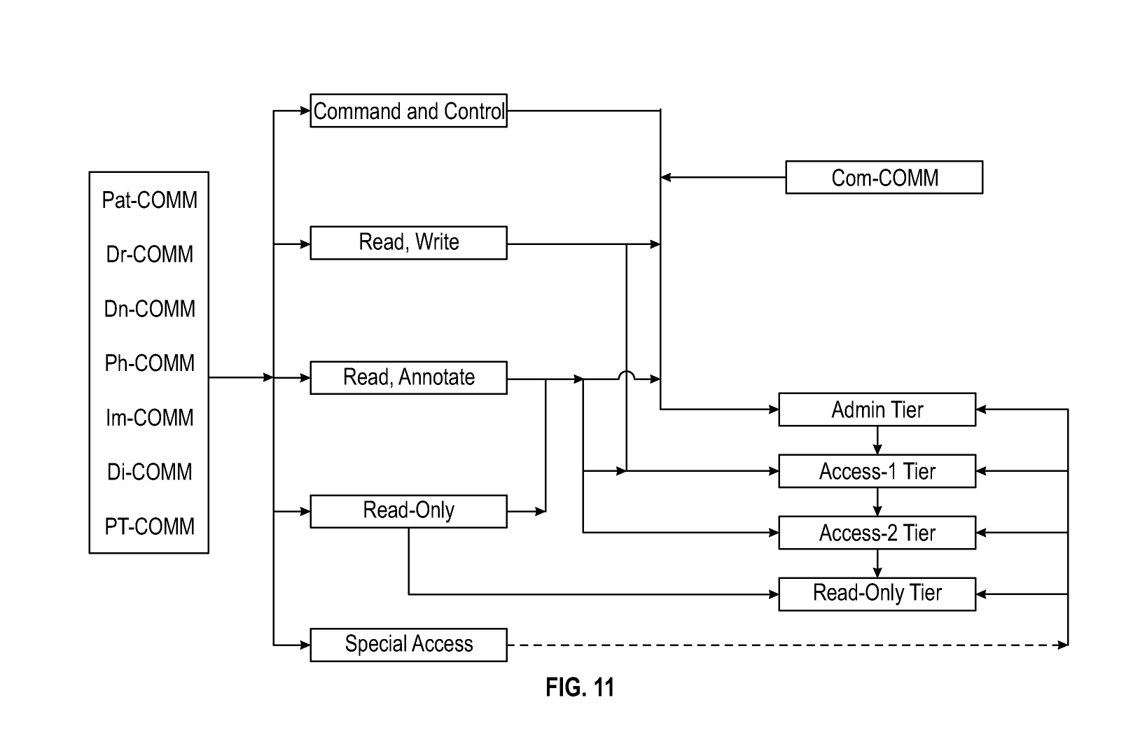

FIG. 11 is a block diagram view of vertical access tiers providing access privileges between authorized users enabled for each COMM.

### DETAILED DESCRIPTION OF THE DRAWINGS

With reference now to the drawings, and in particular FIGS. 1 through 11 thereof, example of the instant practitioner network and patient coordinated healthcare system employing the principles and concepts of the present practitioner network and patient coordinated healthcare system will be described.

Referring to FIGS. 1 through 11 a preferred embodiment of the practitioner network and patient coordinated healthcare system is illustrated.

The present practitioner and patient coordinated healthcare system has been devised to enable a centralized database accessible and sharable between practitioners and patients whereby an electronic coordinated care portfolio (“ECCP”) comprising a patient history, which may include treatments provided across multiple disciplines for example, is readily accessible by all caregivers and thereby readily determinable by any user having access to said database for coordinated and informed care between caregivers.

The present method includes use of tiered access levels to various data sets comprising a patient history, whereby read and write privileges are separated depending on the particular user (whether patient or particular caregiver, for example) and update to patient history is compartmentalized between users. Further, a particular, unique file format is rendered for data handling whereby said patient history is encoded as data to a digital storage medium according to security protocols that enable system-wide handling appropriate to meet confidentiality concerns. In the present application for utility patent, this file format will be designated by the extension “.hlsx” as example only, but any unique extension may ultimately be used. This unique file extension enables security protocols, default security protocols, and file handling to be controlled across any system.

Thus the present practitioner and patient coordinated healthcare system includes a central database. This database may be remotely hosted or cloud based, and the term “central database” should not be taken to mean a single, physical hard drive. Data may be stored decentralized over the Internet, partitioned, and connected in network, to populate a patient portal runnable upon any end-user peripheral device authorized to access said central database. Said central database may, therefore, comprise data streams that are coordinated from multiple sources, separated, partitioned, and secured, to populate data assembled for view via a patient portal. Thus encryption may be applied at each such source of data whereby access to entire patient history is partitioned between individual cryptographic keys. Thus the “centralizing” of data is effected when the patient portal is run on any particular peripheral device by an end user.

Data encoded as “.hlsx” file format, therefore, downloads “.hlsx” files from encrypted data streams delivered via secure Internet protocol to populate the patient portal and assemble the patient history for view. The patient portal is a graphic user interface (“GUI”) wherein command and control of data is enabled by end user interaction with said GUI and the patient history is displayed. The extent of end user command and control is dictated by access privileges between access tiers, as will be described subsequently.

The patient portal, therefore, includes a default screen (“home base”) wherein patient information is stored and displayed. Patient information includes patient identification and contact information, and may include other biometric or other data pertinent to all caregivers, such as height, weight, blood pressure, blood type, primary caregiver(s) information, insurance information, current prescriptions, medication schedules, and the like. Access to all other tiers is enabled through the default screen. Each of a plurality of communication portals (“COMMs”) is accessible from the default screen, each of said COMMs comprising individual access tiers and datasets controllable by particular caregivers.

COMMs may be customizable and approvable by the particular patient, whereby any particular caregiver may be granted access privileges to access tiers in any particular COMM. A default COMM list, for example, includes: a Patient COMM (“Pat-COMM”), a Doctor COMM (“Dr-COMM”), a Diagnostic COMM (“Dn-COMM”), a Pharmacy COMM (“Ph-COMM”), an Imaging COMM (“Im-COMM”), a Dietary COMM (“Di-COMM”), and a Physical Therapy COMM (“PT-COMM”). Each of said COMMs is partitioned from other COMMs with a unique set of access tiers, each access tier accessible by unique access privileges controllable by patient through the Pat-COMM and/or the primary caregiver controllable through the Dr-COMM, as will be described subsequently.

Vertical access tiers devised to control access privileges and restrict command and control of relevant data include command and control tier, read and write tier, read and annotate tier, and read-only tier. Each of these vertical access tiers is explained hereinbelow. Special access may also be enabled for designated restricted access data, as will also be explained hereinbelow.

Command and control tier enables “Admin” users and grants command and control of all data in a particular COMM whereby data is deletable, updateable, rewriteable, readable, and access privileges are assignable to additional users at admin's discretion. Admin may also have access to read data in the entire patient history.

Read and write tier enables “Access-1” users and grants ability to read all data stored and displayed in a particular COMM and update said COMM's data. Deletion of data is prevented, and data overwritten is maintained in patient history for display when desired.

Read and annotate tier enables “Access-2” users and grants ability to read all data stored and displayed in a particular COMM and add annotations to COMM, but data in the COMM is otherwise unchangeable.

Read-only tier enables “read-only users” and grants access to COMM to read data without ability to write, annotate, or overwrite data. Any user with access privileges to any COMM may have read-only access to all other COMMs, unless a particular COMM includes restricted access enabled wherein access to particular data of a COMM requires special access privileges. Other tiers may have cross-COMM access at different tiers.

Any Admin may designate data in the particular COMM as restricted access whereby special access must be granted to read said data so designated. Admin may grant read and write privileges to restricted access data, as needed.

Any change rendered to data below administration tier is time stamped. Users effecting deletions and changes to data may also be tracked and identified whereby log files are stored and maintained whereby tracking of data modification by user is enabled.

Discussing FIG. 1, an example embodiment of a default screen 2 for a patient is illustrated. Patient picture 4, name 6, and patient data 8 are displayed. Pat-COMM link 10, Dr-COMM link 12, Dn-COMM link 14, Ph-COMM link 16, Im-COMM link 18, Di-COMM link 20, and PT-COMM link 22, are selectable to enter each said COMM to read data or read and write data, depending on the access privileges enabled for the particular user. Communication COMM (“Com-COMM”) link 24 is also selectable whereby communications between patient and caregivers is ascertainable.

FIG. 2 illustrates an example embodiment of the Pat-COMM. Selection of the Pat-COMM link 10 on the default screen 2, opens the Pat-COMM panel 28. In this example embodiment, the Pat-COMM panel 28 includes patient notations panel 30, “Add Note” button 32, previous patient notes 34 and a patient survey 36 which, when filled in by patient, may automate population of data fields throughout the ECCP and across all relevant COMMs.

FIG. 3 illustrates an example embodiment of the Dr-COMM. Dr-COMM link selected 38 on the default screen 2 opens the Dr-COMM panel 40. Dr-COMM panel 40 includes Doctor notations panel with “Add note” button 42 and previous notations 44 displayed. Additional fields and displays are contemplated as part of this invention. Upload of notes is available only to Access-2 users and above. Deletion of notes is enabled only by Admin users.

FIG. 4 illustrates an example embodiment of the Dn-COMM. Dn-COMM link selected 46 on the default screen 2 opens the Dn-COMM panel 48 wherein test results 52 are downloadable by qualified user as independent files for private viewing. Some test results may include restricted access. An “Add Report” button 50 enables upload of a new test result to the patient history by Access-2 users and above. Only Admin users can delete data. Download may be restricted from read-only users, wherein view of results in the portal is enabled (unless designated restricted access) but download to a local or peripheral device is denied. A test results data field 54 may show data points from recent test activity or a particular report or may record tests performed. An “Add note” button 58 enables upload of new notes 60 and annotations for storage to the patient history for qualified users (i.e. level-2 users or above).

FIG. 5 illustrates an example embodiment of the Ph-COMM. Ph-COMM link selected 62 opens the Ph-COMM panel 64 wherein prescriptions data 66 is accessible. An “Add Prescription” button 68 enables upload of new prescription 70 by an Access-1 or Admin user. Crossover between Admin users on the Dr-COMM and the prescription data 66 may be enabled whereby a primary caregiver can prescribe medication through the Dr-COMM which is subsequently filled at the pharmacy through the Ph-COMM. An “Add Note” button 74 allows Pharmacist Notes 72 to be uploaded wherein, in this example, a note from another caregiver (“doctor”) 76 provides relevant information when filling another prescription. Notes may be restricted, for example, only added by Access-1 users.

FIG. 6 illustrates an example embodiment of the Im-COMM. Im-COMM link selected 78 opens the Im-COMM panel 80 wherein imaging results 82 are accessible to all users unless restricted access has been applied to any particular image result. Only tiers above Access-2 users can upload data. Only Access-1 users and above can download data to save to local or peripheral device. An “Add Image” button 84 enables upload of image results 86 by a qualified (Access-1 and above) user to an Imaging Director Note panel 88. An “Add Notes” button 90 enables upload of notes 92 to all users at tiers Access-2 or above. Add Image button 84 and Add Notes button 90 may not be visible or selectable when a user is determined beneath the requisite tier to upload data. Images may be stored as known file types wrapped in the overall “.hlsx” file, or encrypted and downloadable as known image file types from the Im-COMM when a user is determined to be authorized to download said image files.

FIG. 7 illustrates an example embodiment of the Di-COMM. Di-COMM link selected 94 on the default screen opens the Di-COMM panel 96 wherein notes 100 from a nutritionist or other dietary professional or caregiver are uploadable at tier Access 2 or above by clicking upon the “Add Note” button 98. Add note button 98 may not be visible or selectable when a user is beneath the requisite tier to upload data.

FIG. 8 illustrates an example embodiment of the PT-COMM. PT-COMM link selected 102 opens the PT-COMM panel 104. Access-2 users and above may add notes 108 by selection of the “Add Note” button 106. Add note button 106 may not be visible or selectable when a user is beneath the requisite tier to upload data.

FIG. 9 illustrates an example embodiment of the Com-COMM. Com-COMM link selected 110 presents confirmation screen 112 wherein confirmation will email the patient history as a single file 11 to a desired destination address. Only patient and/or Admin tier users can send patient history through the Com-COMM. Secure SMTP or other secure protocol may be enacted when sending ECCP through the Com-COMM including the use of the unique file format, herein “.hlsx”, whereby particular security protocols are enacted when handling the “.hlsx” file and use of a particular application is required to read and open said “.hlsx” file.

FIG. 10 illustrates a flow diagram showing an example network enabled by the present practitioner network and patient coordinated healthcare system 10, connecting patients 114 with doctors 116, laboratories 118, pharmacists 120, radiologists 122, nutritionists 124, and physical therapists 126, through a HIPAA compliant firewall 130 for confidential handling of patient history as .hlsx files configured as an ECCP 138 through the central server 134 and accessed by the patient portal.

It should be noted that every ECCP 138 stored in the central server 134 may be comprised of separate, disjointed “.hslx” files. When viewing an ECCP 138, files are sourced remotely and assembled at the peripheral device by action decoding cryptographic keys paired to the individual user accounts (including designated practitioners as well as the patient). Thus data streams are fragmented and encoded whereby interception and unauthorized access of data comprising an ECCP is 138 is preventable.

Thus the present practitioner network and patient coordinated healthcare system 10 enables increased interdepartmental communication and sharing of sensitive medical information between caregivers and practitioners by enabling a patient history with controllable access through a patient portal to access a central database wherein unique “.hlsx” files may be encoded for particular secure handling over and across the network. Thus only the patient portal will be able to open “.hlsx” files, each “.hlsx” file encrypted with private keys matchable with public-private keys integrated with the particular patient portal at the time said “.hlsx” files are created whereby unauthorized access is preventable.

What is claimed is:

1. A practitioner network and patient coordinated healthcare system comprising:
an ECCP accessible over a network and displayable upon a peripheral device, said ECCP comprising:
a GUI coordinating between a plurality of COMMs, each of said plurality of COMMs securely partitioned and selectively displayable between authorized users upon a peripheral device;
wherein a patient history is storable between tiered access levels as various data sets and read and write privileges are controllable to update and/or access said patient history compartmentalized between authorized users over the network.

2. The practitioner network and patient coordinated healthcare system of claim 1 wherein the ECCP is transferable between authorized users over the network as a unique file format enabling specific security protocols for default file handling of an ECCP file wrapper.

3. The practitioner network and patient coordinated healthcare system of claim 2 wherein a data set peculiar to each of the plurality of COMMs is pulled from a plurality of sources via network, said data set encoded cryptographically and independently, whereby any one data set is partitioned from other data sets comprising the ECCP until assembled for end user display at an authorized peripheral device.

4. The practitioner network and patient coordinated healthcare system of claim 3 wherein the plurality of COMMs includes:
a Pat-COMM;
a Dr-COMM;
a Dn-COMM;
a Ph-COMM;
an Im-COMM;
a Di-COMM;
a PT-COMM; and
a Com-COMM;
wherein access between, and command and control of, each of said plurality of COMMs is controllable across vertical access tiers assignable to specific authorized users.

5. The practitioner network and patient coordinated healthcare system of claim 4 wherein the vertical access tiers include:
admin users able to access, read, write, and delete data across all COMMs comprising an ECCP, and deputize additional users with any vertical access tier privilege;
access-1 users able to upload, download, and overwrite data, but not delete data from any COMM comprising an ECCP, whereby changes made to the ECCP are displayable as part of a history;
access-2 users able to read and annotate data comprising specific COMM files, but unable to download data from the ECCP for separate storage or transfer, or render any changes to data displayable as part of any COMM; and
read-only users able to view and read annotations in particular COMM files to which access has been granted by an admin user or, in some cases, an access-1 user;
wherein each COMM is partitionable and access thereto restrictable between users and a single ECCP for a single patient may comprise multiple users at each vertical access tier, each tier operative distinctly for each COMM.

6. The practitioner network and patient coordinated healthcare system of claim 5 wherein an end user not designated as a read only user may create restricted access partitions to uploaded data and assign access to particular end users.

7. The practitioner network and patient coordinated healthcare system of claim 6 wherein the GUI of the ECCP displayable upon the peripheral device comprises:
a default screen displaying patient information, said patient information including patient name, patient photograph, patient contact information, patient biometric data, patient insurance information, patient medication information, patient prescription information, patient caregiver information, and practitioner information; and
selectable link access to each of the plurality of COMMs.

8. The practitioner network and patient coordinated healthcare system of claim 7 wherein the Pat-COMM panel is selectable for upload of comments and annotations made by the patient and accessible between authorized users as designated by the patient, said Pat-COMM panel including:
an “add notes” button selectable to add new notes to the patient history;
a previous patient notes display, displaying previous notes uploaded to the Pat-COMM panel, said previous notes displayable chronologically and, when selected, by priority; and
a patient survey devised to collect data by prompting the patient and automate population of relevant data fields throughout the plurality of COMMs.

9. The practitioner network and patient coordinated healthcare system of claim 8 wherein the Dr-COMM includes:
a Dr-COMM panel selectable for upload of comments and annotations made by a practitioner and/or caregiver with authorized access above a read only user vertical access tier, said Dr-COMM panel including:
an “add note” button selectable to add new notes to the patient history; and
a previous notes display, displaying previous notes uploaded to the Dr-COMM panel, said previous notes displayable chronologically and, when selected, by priority.

10. The practitioner network and patient coordinated healthcare system of claim 9 wherein the Dn-COMM includes:
a Dn-COMM panel where test results and diagnostics are displayable, and when accessed by an authorized user, downloadable for private viewing, said Dn-COMM panel including:
an “add report” button selectable to enable upload of data by authorized users at access-2 or above;
a test results data field wherein data points from recent test activity and/or a particular test results are displayable; and
an “add note” button selectable by authorized users to add new notes to the patient history.

11. The practitioner network and patient coordinated healthcare system of claim 10 wherein the Ph-COMM includes:
a Ph-COMM panel wherein prescription data is accessible to authorized users, said Ph-COMM panel including:
an “add prescription” button selectable for upload of prescription information by authorized users; and
an “add note” button selectable by authorized users to add new notes to the patient history.

12. The practitioner network and patient coordinated healthcare system of claim 11 wherein the Im-COMM includes:
an Im-COMM panel wherein imaging results are accessible to all users as established image file formats, unless restricted access has been applied to any particular image result, said image file types packageable and extractable from the ECCP unique file wrapper, said Im-COMM panel including:
upload authorization for access-2, access-1, and admin users;
download authorization for access-1 and admin users only;
an “add image” button selectable to enable upload of imaging results by authorized users;
an “add note” button selectable by authorized users to add new notes to the patient history.

13. The practitioner network and patient coordinated healthcare system of claim 12 wherein the Di-COMM includes:
a Di-COMM panel wherein dietary instructions and notations are displayable to authorized users, said Di-COMM panel including:
an “add note” button selectable by authorized users to add new notes to the patient history whereby dietary procedures performed are recordable.

14. The practitioner network and patient coordinated healthcare system of claim 13 wherein the PT-COMM includes:
a PT-COMM panel wherein physical therapy instructions and regimens are accessible to authorized users, said PT-COMM panel including:
an “add note” button selectable by authorized users to add new notes to the patient history whereby physical therapy performed is recordable.

15. The practitioner network and patient coordinated healthcare system of claim 14 wherein the Com-COMM includes:
a Com-COMM link selectable by an authorized user to effect automated generation of the ECCP file wrapper as an attachment for electronic distribution, said ECCP file wrapper enabling default security handling protocols for transfer, receipt, and viewing capabilities of the ECCP.

16. The practitioner network and patient coordinated healthcare system of claim 15 wherein the ECCP file wrapper unique file format is designated by a .hlsx extension.

17. The practitioner network and patient coordinated healthcare system of claim 15 wherein a specific software application is required to extract data from the ECCP file wrapper whereby absence of said specific software application renders the data unreadable.

18. The practitioner network and patient coordinated healthcare system of claim 17 wherein the ECCP file wrapper is assembled from individual files separably stored and remotely sourced, each said individual file and encrypted by generation of an individual cryptographic key matchable with a private key peculiar to individual users, including designated practitioners and patients.
